(19) United States
(12) Patent Application Publication
(10) Pub. No.: US 2026/0079482 A1
(43) Pub. Date: Mar. 19, 2026

(54) ABNORMALITY DETERMINATION DEVICE AND ABNORMALITY DETERMINATION METHOD

(71) Applicant: Panasonic Intellectual Property Management Co., Ltd., Osaka (JP)

(72) Inventors: YURINA NAGASAWA, Osaka (JP); YUTA SHIMAZAKI, Osaka (JP)

(21) Appl. No.: 19/119,731

(22) PCT Filed: Sep. 20, 2023
(86) PCT No.: PCT/JP2023/034163

§ 371 Date: Apr. 9, 2025

(30) Foreign Application Priority Data
Nov. 29, 2022 (JP) 2022-189916

(51) Int. Cl. G05B 23/02

(52) U.S. Cl. CPC G05B 23/0235

(57) ABSTRACT

An abnormality determination device include: a learning unit configured to provide an abnormality detection model for detecting an abnormality of a facility by machine learning using log data that represent operation performance of the facility; a determination unit configured to input data representing operation performance of a target facility and determine an abnormality of the target facility; and an output unit configured to output a determination result by the determination unit. If the determination result is different from an evaluation result of an on-site checking of the target facility, the learning unit is configured to update the abnormality detection model based on the evaluation result.

### TECHNICAL FIELD

The present disclosure relates to an abnormality determination device and an abnormality determination method.

### BACKGROUND ART

In recent years, use of machine learning in various fields has been considered, and research and development of technologies to enhance the accuracy of machine learning have been performed (see, for example, PTL 1 and PTL 2).

### CITATION LIST

### Patent Literature

PTL 1: Japanese Patent Laid-Open Publication No. 2021-32115
PTL 2: Japanese Patent Laid-Open Publication No. 2016-143352

### SUMMARY OF INVENTION

In determining an abnormality of facilities by using machine learning, accuracy needs to be improved.

An abnormality determination device according to an aspect of the present disclosure includes: a learning unit configured to provide an abnormality detection model for detecting an abnormality of a facility by machine learning using log data that represent operation performance of the facility; a determination unit configured to input data representing operation performance of a target facility and determine an abnormality of the target facility; and an output unit configured to output a determination result by the determination unit. If the determination result is different from an evaluation result of an on-site checking of the target facility, the learning unit is configured to update the abnormality detection model based on the evaluation result.

An abnormality determination method according to an aspect of the present disclosure comprises: creating an abnormality detection model, for detecting an abnormality of a facility, by machine learning using log data representing operation performance of the facility; determining an abnormality of a target facility by inputting data representing operation performance of the target facility to the abnormality detection model; and outputting a result obtained by said determining of the abnormality. In said creating the abnormality detection model, if the result is different from an evaluation result of the target facility by an on-site checking, the abnormality detection model is updated based on the evaluation result.

Furthermore, an aspect of the present disclosure can be implemented as a program for causing a computer to execute the above-mentioned abnormality determination method. Alternatively, an aspect of the present disclosure can also be implemented as a computer-readable non-temporary recording medium containing the program.

According to the present disclosure, abnormalities are determined accurately.

### BRIEF DESCRIPTION OF DRAWINGS

FIG. 1 illustrates a configuration of an abnormality determination system according to an exemplary embodiment.

FIG. 2 is a block diagram of an abnormality determination device according to the embodiment.

FIG. 3 is a block diagram of an input/output device according to the embodiment.

FIG. 4 is a flowchart illustrating a process of a learning phase of the abnormality determination system according to the embodiment.

FIG. 5 illustrates a process of the abnormality determination device according to the exemplary embodiment.

FIG. 6 illustrates an example of learning data for machine learning.

FIG. 7 is a flowchart illustrates a process of a use phase of the abnormality determination system according to the embodiment.

FIG. 8 illustrates an example of re-learning data of the machine learning.

FIG. 9 is a flowchart illustrating a process relating to an on-site checking of the abnormality determination system according to the embodiment.

FIG. 10 illustrates an example of a notification screen that displays an abnormality determination result.

FIG. 11 illustrates an example of evaluation data representing evaluation results obtained by an on-site checking.

### DESCRIPTION OF EMBODIMENTS

### Outline of Present Disclosure

An abnormality determination device includes: a learning unit configured to provide an abnormality detection model for detecting an abnormality of a facility by machine learning using log data that represent operation performance of the facility; a determination unit configured to input data representing operation performance of a target facility and determine an abnormality of the target facility; and an output unit configured to output a determination result by the determination unit. If the determination result is different from an evaluation result of an on-site checking of the target facility, the learning unit is configured to update the abnormality detection model based on the evaluation result.

The anomaly detection model is updated based on the evaluation result obtained by an on-site checking, allowing the abnormality detection model to reflect a real state of a target facility that may not be obtainable from the data of the target facility. This configuration enhances the accuracy of the abnormality detection model and allows the abnormality determination device according to this aspect to determine an abnormality accurately.

The abnormality determination device according to a second aspect of the present disclosure includes a comparison unit configured to make a comparison of the determination result with the evaluation result. If the determination result is different from the evaluation result, the learning unit is configured to update the abnormality detection model based on the evaluation result.

A worker is only required to perform an evaluation by an on-site checking and to input an evaluation result, and does not need to compare the evaluation result with the determination result. Therefore, the abnormality determination device according to this aspect reduces a burden on the worker, thereby enhancing both convenience and accuracy in abnormality determination.

In the abnormality determination device according to a third aspect of the present disclosure, in the abnormality determination device according to the second aspect, if the determination result indicates that the target facility is abnormal, the comparison unit is configured to make the comparison. If the determination result indicates that the target facility is normal, the comparison unit is configured not to make the comparison.

This configuration urges a worker to perform an on-site checking only if an abnormality is determined. The number of times of on-site checking is reduced, and a burden on the worker is reduced accordingly. This enhances both convenience and accuracy of determining an abnormality.

In the abnormality determination device according to a fourth aspect of the present disclosure, in the abnormality determination device according to any one of the first to third aspects, if the determination result indicates that the target facility is abnormal, the output unit is configured to output the determination result. If the determination result indicates that the target facility is normal, the output unit is configured not to output the determination result.

This configuration urges a worker to perform an on-site checking only if an abnormality is determined. The number of times of on-site checking is reduced, and a burden on the worker is reduced accordingly. This configuration enhances both convenience and accuracy in determining an abnormality.

The abnormality determination device according to a fifth aspect of the present disclosure, in the abnormality determination device according to any one of the first to fourth aspects, includes an acquisition unit configured to acquire the evaluation result.

Since an evaluation result by an on-site checking is acquired, a real state of the target facility that may not be able to be obtained from data of the target facility may be made into data. Therefore, the evaluation results into data stored enhances accuracy of the abnormality detection model.

The abnormality determination device according to a sixth aspect of the present disclosure and includes a storage unit configured to store the log data and the abnormality detection model.

This configuration facilitates to access the data needed to create and use an abnormality detection model, and contributes to faster processing and less power consumption.

The abnormality detection method according to a seventh aspect of the present disclosure comprises: creating an abnormality detection model, for detecting an abnormality of a facility, by machine learning using log data representing operation performance of the facility; determining an abnormality of a target facility by inputting data representing operation performance of the target facility to the abnormality detection model; and outputting a result obtained by said determining of the abnormality. If the result is different from an evaluation result of the target facility by an on-site checking, said creating the abnormality detection model comprises updating the abnormality detection model based on the evaluation result.

Since the abnormality detection model is updated based on the evaluation result obtained by an on-site checking, the abnormality detection model reflects a real condition of a target facility that may not be obtainable from the data of the target facility. This configuration enhances the accuracy of the abnormality detection model, and therefore, the abnormality determination method according to this aspect determines the abnormality accurately, similar to the abnormality determination device according to the aspects described above.

A program according to an eighth aspect of the present disclosure is a program for causing a computer to execute the abnormality determination method according to any one of the first to seventh aspects.

Abnormality is determined accurately, similar to the abnormality determination device according to each of the above-mentioned aspects described above.

Exemplary embodiment will be described below with reference to the drawings.

The exemplary embodiments described below show generic or specific examples. The numerical values, shapes, materials, constituent elements, arrangements and connections of constituent elements, steps, the order of the steps, and the like, shown in the following exemplary embodiments are examples, and therefore do not intend to limit the present disclosure. Furthermore, among the constituent elements in the following exemplary embodiments, constituent elements not recited in an independent claim are described as arbitrary constituent elements.

Each drawing is a schematic diagram and is not necessarily an exact illustration. Therefore, for example, the scales and the like of each drawing do not necessarily agree with each other. Furthermore, in each drawing, the same reference numerals are given to substantially the same configurations, and duplicate descriptions are omitted or simplified.

### Exemplary Embodiment

### Overview

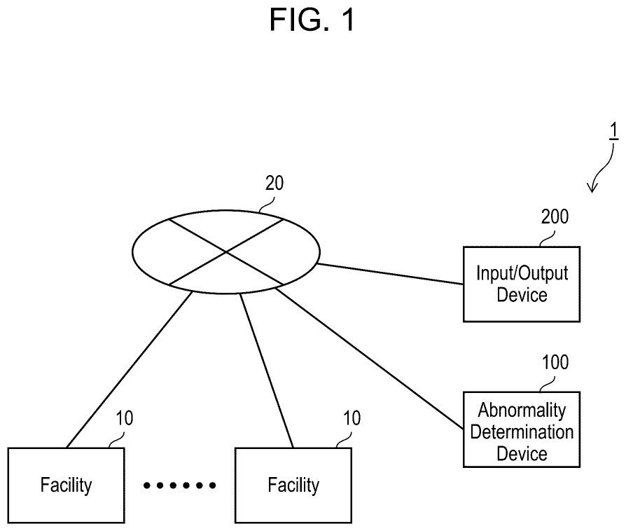

An overview of an abnormality determination system according to an exemplary embodiment will be described with reference to FIG. 1. FIG. 1 illustrates abnormality determination system 1 according to the embodiment.

Abnormality determination system 1 shown in FIG. 1 is used in production systems of, for example, factories, and is a system for determining an abnormality in a facility. In detail, abnormality determination system 1 creates an abnormality detection model using machine learning, and determines an abnormality in a target facility using the created abnormality detection model.

As shown in FIG. 1, abnormality determination system 1 includes plural facilities 10, abnormality determination device 100, and input/output device 200. Facilities 10, abnormality determination device 100, and input/output device 200 are communicably coupled via network 20. Communication is performed by wireless communication or wired communication, or in combination thereof.

Each facility 10 is a manufacturing facility configured to execute one process out of plural processes for manufacturing products. Facility 10 is, for example, a component mounting device, a working device, or an assembly device, but is not particularly limited to these. Facility 10 is configured to produce members by executing processes, and outputs the produced members.

The members are, for example, components included in a final product (that is, a product) or a workpiece in progress in the middle of manufacturing the final product, but are not limited to these. The members are objects used to produce components or workpieces in progress, and is not necessarily included in a final product. Facility 10 may be any facility related to manufacturing of products, and may be a check device for checking members, workpieces in progress, or products.

In this description, “manufacturing” does not only mean creating a final product, but also includes working, assembly, check, and the like, of members (components or workpieces in progress). For example, the member manufactured by facility 10 is a member output after facility 10 executes the assigned process (working, assembly, check, or the like). Furthermore, “manufacturing” is an example of “production.” If the final product is an industrial product, “manufacturing” is used in the same meaning as “production.” The final product is not limited to industrial products, and may be, for example, an item manufactured or produced in a food factory or a plant factory.

In this embodiment, each facility 10 manufactures a product by executing a predetermined process. The number of facilities 10 is not particularly limited. The number facility 10 may be one. In other words, one facility 10 may manufacture a product. Normality of facility 10 means that facility 10 executes a predetermined process. Abnormality of facility 10 means that that facility 10 executes a process that is not the predetermined process, or does not execute the predetermined process.

Abnormality determination device 100 is a device configured to determine the abnormality of facility 10. Specifically, abnormality determination device 100 is configured to determine whether or not an abnormality occurred in each facility 10 by using machine learning.

Abnormality determination device 100 is one or more computer apparatuses including a processor and a memory. The processor reads and executes a program stored in the memory to perform processing relating to determination of abnormality. At least a part of the processing executed by abnormality determination device 100 may be executed by a dedicated circuit.

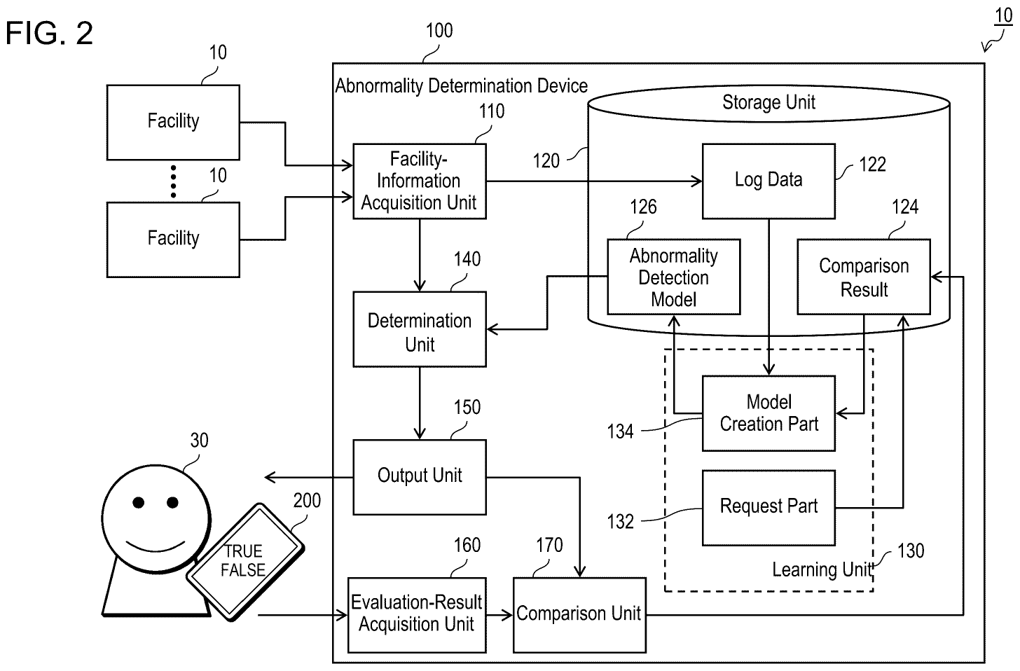

Input/output device 200 is a device configured to present (output) information to worker 30 (see FIG. 2) and acquires (inputs) information from worker 30. Worker 30 is, for example, a person who performs maintenance and management of facility 10. Input/output device 200 is an operation terminal possessed by worker 30, and is, for example, a mobile terminal, such as a tablet PC and a smartphone.

Input/output device 200 is not limited to a mobile terminal, and may be a stationary computer apparatus. For example, input/output device 200 may be configured integrally with abnormality determination device 100. Input/output device 200 may be implemented by an input device and an output device different from each other.

In order to enhance productivity of products, the operating rate of facility 10 is required to be enhanced by detecting abnormalities in facility 10 and quickly dealing with the detected abnormalities. An abnormality detection model created by machine learning is used to detect the abnormalities. An accurate abnormality detection model suppresses occurrence of misdetection and leakage of detection of abnormalities, enhancing the operating rate of facility 10.

In order to enhance the accuracy of the abnormality detection model, it is required to obtain appropriate feedback on the determination results and use the feedback result for updating the abnormality detection model. Facility 10 includes one or more sensors for detecting the operating status of the facility. Log data representing operation performance of the facility is generated based on the sensor values output from the sensors, and the log data are used for machine learning. Therefore, it is possible to update the abnormality detection model by performing feedback using data based on sensor values determined to be abnormal.

However, since abnormalities in facility 10 may occur due to various factors, data based on sensor values may not appropriately represent the abnormality condition of facility 10. In this cases, feedback using sensor values may not allow update the abnormality detection model to be appropriately updated.

Abnormality determination device 100 according to this embodiment updates the abnormality detection model based on the evaluation results of facility 10 by an on-site checking. The on-site checking is a check of the status of facility 10, and is performed by worker 30 on site. The “on-site” refers to at a place where facility 10 is actually installed. The on-site checking includes a checking of facility 10 by worker 30 by visual check of facility 10, and a check of the operating status of facility 10 using, e.g., a checking device. Worker 30 inputs, via input/output device 200, the evaluation results obtained by the on-site checking.

In accordance with this embodiment, since the abnormality detection model is updated based on the evaluation results of the on-site checking, a real state of the facility, which may not be obtained from the data of facility 10, can be reflected on the abnormality detection model. This configuration enhances the accuracy of the abnormality detection model, so that abnormality determination device 100 may determine abnormalities accurately.

### Abnormality Determination Device

Abnormality determination device 100 will be described below with reference to FIG. 2. FIG. 2 is a block diagram of abnormality determination device 100 according to this embodiment.

As shown in FIG. 2, abnormality determination device 100 includes facility-information acquisition unit 110, storage unit 120, learning unit 130, determination unit 140, output unit 150, evaluation-result acquisition unit 160, and comparison unit 170.

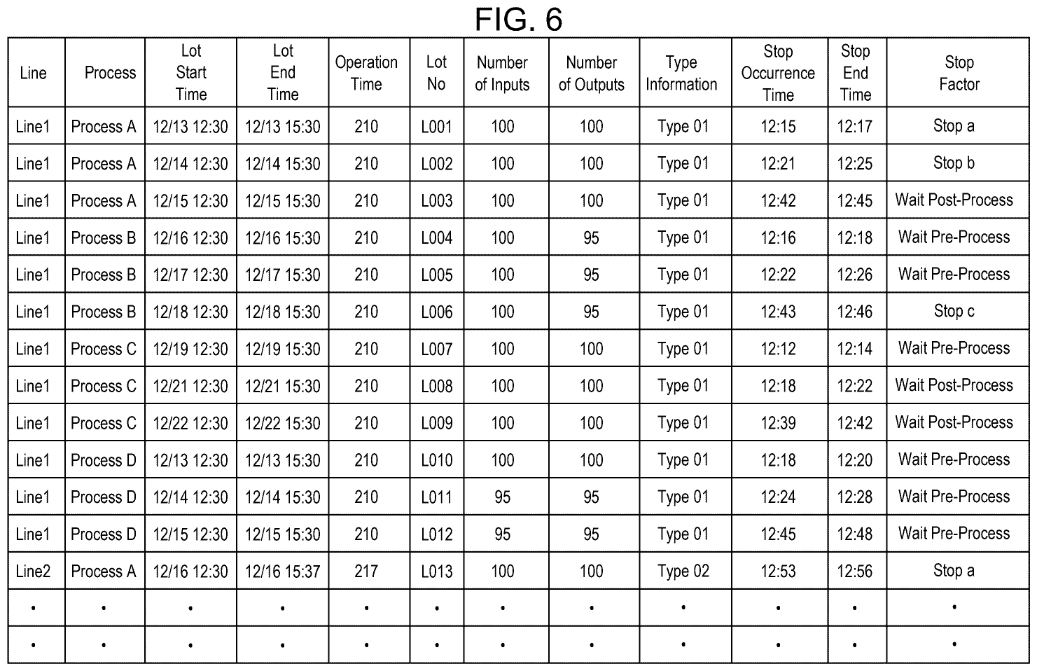

Facility-information acquisition unit 110 is configured to acquire facility data of each facility 10 from the facility 10. The facility data includes the sensor values described above. Facility-information acquisition unit 110 generates log data 122 representing operation performance of facility 10 based on the acquired facility data and stores log data 122 in storage unit 120. A specific example of log data 122 will be described later with reference to FIG. 6.

Facility-information acquisition unit 110 also acquires, from the target facility, facility data including a sensor value that is a source of input data to be used for determining an abnormality. The target facility is one or more facilities on which abnormalities are determined, and may be one or more, or all the facilities 10.

Storage unit 120 is configured to store data used by abnormality determination device 100. As shown in FIG. 2, storage unit 120 stores log data 122, comparison result 124, and abnormality detection model 126.

Learning unit 130 creates abnormality detection model 126 for detecting an abnormality in facility 10 by machine learning using log data 122. If the determination result by determination unit 140 is different from the evaluation result of facility 10 based on an on-site checking, learning unit 130 updates abnormality detection model 126 based on the evaluation result.

As shown in FIG. 2, learning unit 130 includes request part 132 and model creation part 134.

Request part 132 is configured to request the stored data to storage unit 120. For example, request part 132 requests log data 122 necessary for creating abnormality detection model 126. Request part 132 also requests log data 122 and comparison results 124 necessary for updating abnormality detection model 126.

Model creation part 134 creates abnormality detection model 126 by machine learning using log data 122. Model creation part 134 updates abnormality detection model 126 based on log data 122 and comparison result 124.

Determination unit 140 inputs data representing the operation performance of the target facility to abnormality detection model 126 to determine an abnormality in the target facility. Determination unit 140 outputs the determination result for each facility 10 to output unit 150.

The determination result includes information indicating whether the target facility is abnormal or not (or is normal). In addition, if the target facility is determined to be abnormal, the determination result may further include information for identifying a factor of the abnormality.

Output unit 150 outputs the determination result by determination unit 140. Output unit 150 outputs the determination result to input/output device 200 and comparison unit 170. Alternatively, instead of outputting the determination result to input/output device 200, output unit 150 may output the determination result to an output device, such as a display device, which is different from input/output device 200. For example, output unit 150 may output the determination result to a monitor screen installed in a factory, and inform worker 30 in the factory of the determination result.

Output unit 150 outputs the determination result if the determination result indicates that the target facility is abnormal. Output unit 150 does not output the determination result if determination result indicates that the target facility is normal. This configuration urges worker 30 to check the site only if the target facility is abnormal. The number of times that the target facility is determined to be abnormal is less than the number of times that it is determined to be normal. Therefore, this configuration allows the on-site checking to be less frequently performed and reduce a burden on worker 30.

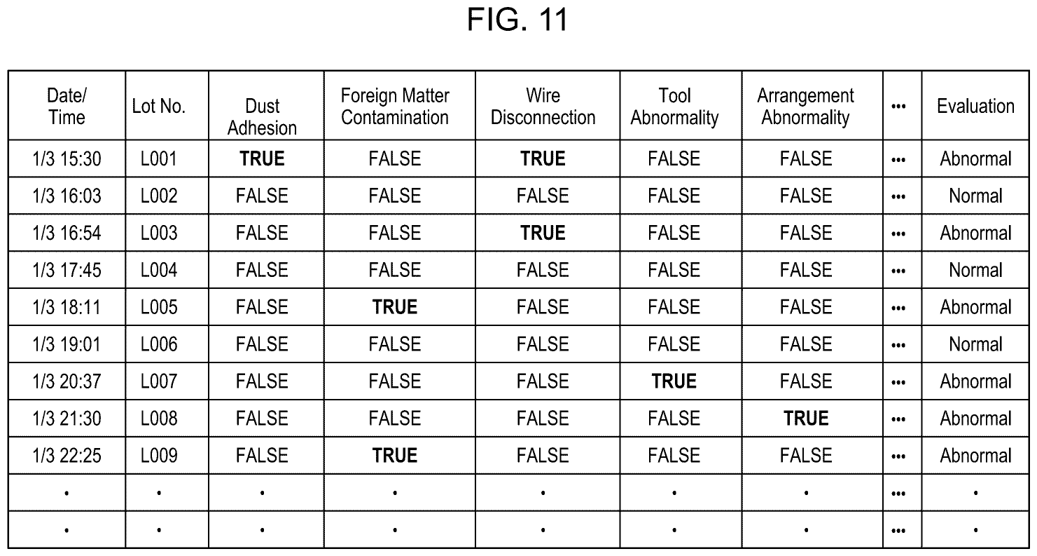

Evaluation-result acquisition unit 160 acquires the evaluation results of the target facility by an on-site checking. In accordance with this embodiment, evaluation-result acquisition unit 160 acquires the evaluation results from input/output device 200. The evaluation results include, for example, the results of the on-site checking as to whether the target facility determined to be abnormal was actually abnormal or normal, and the results of evaluating the status of factors that may cause the abnormality. Specific examples of the evaluation results will be described later with reference to FIG. 11.

Comparison unit 170 compares the determination result by determination unit 140 with the evaluation result acquired by evaluation-result acquisition unit 160. Comparison result 124 by comparison unit 170 is stored in storage unit 120. Comparison result 124 is information indicating whether or not the determination result is consistent with the evaluation result. Comparison result 124 may include the determination result and the evaluation result.

Facility-information acquisition unit 110 is implemented by a communication interface capable of communicating with sensors provided in facilities 10. Storage unit 120 is a non-volatile storage device, e.g., a magnetic disk, such as a hard disk drive (HDD), or a semiconductor memory, such as a solid state drive (SDD). Each of output unit 150 and evaluation-result acquisition unit 160 is implemented by a communication interface capable of communicating with input/output device 200.

Each of learning unit 130, determination unit 140, and comparison unit 170 is implemented by, for example, a large scale integration (LSI) that is an integrated circuit (IC). The integrated circuit is not limited to an LSI, and may be a dedicated circuit or a general-purpose processor. For example, learning unit 130, determination unit 140, and comparison unit 170 may be implemented by a programmable field programmable gate array (FPGA), or a reconfigurable processor in which connections and settings of circuit cells in the LSI can be reconfigured. At least a part of the functions executed by learning unit 130, determination unit 140, and comparison unit 170 may be implemented by software or hardware. Learning unit 130, determination unit 140, and comparison unit 170 may be implemented by common hardware resources.

### Input/Output Device

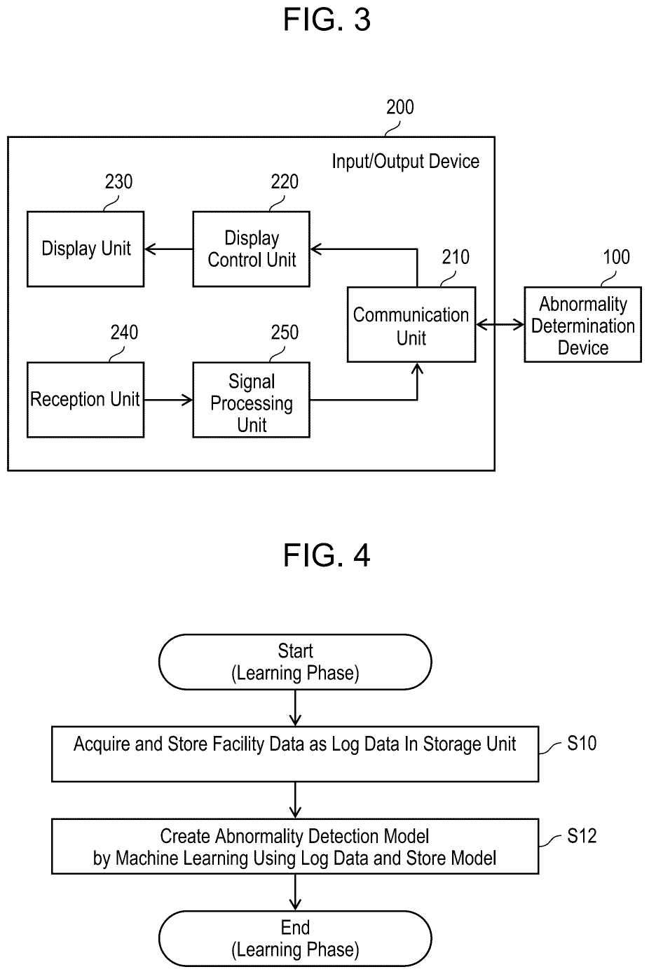

Input/output device 200 will be described below with reference to FIG. 3. FIG. 3 is a block diagram of input/output device 200 according to this embodiment.

As shown in FIG. 3, input/output device 200 includes communication unit 210, display control unit 220, display unit 230, reception unit 240, and signal processing unit 250.

Communication unit 210 transmits and receives information by communicating with abnormality determination device 100. Specifically, communication unit 210 acquires the determination result from output unit 150 of abnormality determination device 100. Communication unit 210 transmits the evaluation result to evaluation-result acquisition unit 160 of abnormality determination device 100. Communication unit 210 is implemented by a communication interface that communicates wired or wirelessly.

Display control unit 220 controls display unit 230. Display control unit 220 generates a notification screen for informing worker 30 of the determination result acquired by communication unit 210, and causes display unit 230 to display the notification screen. Display control unit 220 also generates an input reception screen for receiving input of the evaluation result by the on-site checking performed by worker 30, and causes display unit 230 to display the input reception screen.

Display control unit 220 is implemented by, for example, a large scale integration (LSI) that is an integrated circuit. Display control unit 220 is implemented by, for example, a dedicated integrated circuit, a microcontroller, or a processor. Alternatively, display control unit 220 may be implemented by a programmable field programmable gate array (FPGA), or a reconfigurable processor in which connections and settings of circuit cells in the LSI can be reconfigured. At least a part of the functions executed by display control unit 220 may be implemented by software or hardware.

Display unit 230 displays the image generated by display control unit 220. Specifically, display unit 230 displays a notification screen and an input reception screen. Display unit 230 is, for example, a liquid crystal display device or an organic electroluminescent (EL) display device.

Reception unit 240 receives an operation input from worker 30. Reception unit 240 receives an input regarding the evaluation of the target facility by an on-site checking by worker 30. Reception unit 240 is, for example, a touch sensor, a physical button, or the like. Reception unit 240 may be implemented by a touch panel display together with display unit 230.

Signal processing unit 250 processes the input received by reception unit 240. Signal processing unit 250 generates an evaluation result based on the input received by reception unit 240, and transmits the evaluation result to abnormality determination device 100 via communication unit 210.

Signal processing unit 250 is implemented by, for example, a large scale integration (LSI) that is an integrated circuit. Signal processing unit 250 is implemented by, for example, a dedicated integrated circuit, a microcontroller, or a processor. Alternatively, signal processing unit 250 may be a programmable field programmable gate array (FPGA), or a reconfigurable processor in which connections and settings of circuit cells in the LSI can be reconfigured. At least a part of the functions executed by signal processing unit 250 may be implemented by software or hardware. Signal processing unit 250 and display control unit 220 may be implemented by common hardware resources.

### Operation

An operation of abnormality determination system 1 according to this embodiment will be described below.

The operation of abnormality determination system 1 schematically includes two stages of processing: a learning phase of creating an abnormality detection model by machine learning, and a use phase of using the created abnormality detection model.

### Learning Phase

Firstly, processing of the learning phase will be described with reference to FIG. 4. FIG. 4 is a flowchart illustrating the processing of the learning phase of abnormality determination system 1 according to this embodiment.

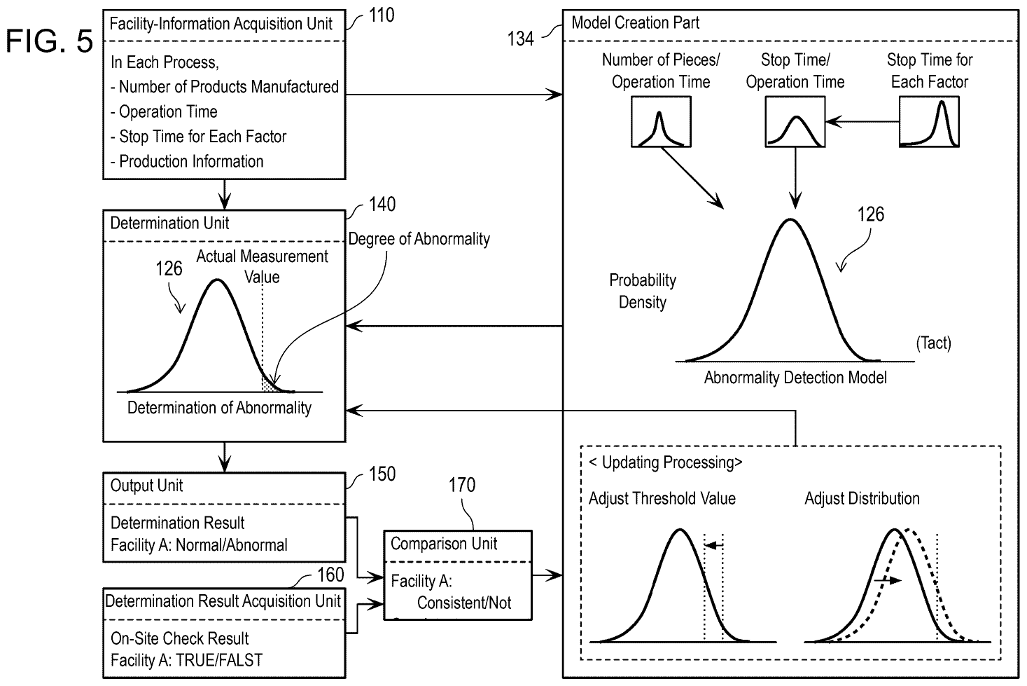

As shown in FIG. 4, firstly, facility-information acquisition unit 110 acquires facility data from facilities 10 and stores the acquired facility data in storage unit 120 as log data 122 (S10). Log data 122 is data indicating the operation performance of each process (each facility). For example, as shown in FIG. 5, the operation performance includes the number of products manufactured, operation time, stop time for each factor, and production information, for each process (each facility). FIG. 5 illustrates the processing of abnormality determination device 100 according to this embodiment. FIG. 5 corresponds to the configuration of abnormality determination device 100 shown in FIG. 2 while not showing storage unit 120 or request part 132.

FIG. 6 illustrates an example of log data 122 for learning by machine learning. In the example shown in FIG. 6, one record (one line of data) is generated for each line, process, and lot number (lot No.). Based on the sensor values detected by the sensor of each facility 10, facility-information acquisition unit 110 generates one line of data for each lot, including the production line, process (facility), lot start time, lot end time, operating time, number of inputs, number of outputs, information on product type, stop occurrence time, stop end time, and stop factor, and stores the data in storage unit 120. One line of data is not limited to the examples shown in FIG. 6, and may include other elements, such as the number of stops and management time.

Next, as shown in FIG. 4, learning unit 130 creates abnormality detection model 126 by machine learning using log data 122 and stores the created model in storage unit 120 (S12). Request part 132 requests storage unit 120 to read out log data 122, and model creation part 134 reads out log data 122 from storage unit 120. Model creation part 134 creates abnormality detection model 126 by performing machine learning using read log data 122.

Abnormality detection model 126 is a learning model used for determining an abnormality in the target facility. As shown in FIG. 5, abnormality detection model 126 corresponds to a probability distribution of a production takt. The probability distribution is defined by the type of the distribution and the value of a parameter. The production takt is a so-called takt time, which is the time required to manufacture one product. Abnormality detection model 126 is created, for example, for each product (for each production line). Abnormality detection model 126 may also be created for each facility (for each process).

Types of the probability distributions include, e.g., normal distribution, log-normal distribution, zero-excess exponential distribution, and gamma distribution. The parameter type of the probability distribution is determined by the type of probability distribution. For example, in normal distribution, it is the mean u and the standard deviation o. The parameter values are generated based on past production performance, that is, log data 122.

The parameters of the learning model may be obtained based on Bayesian estimation. For example, the parameters may be obtained by a sampling method, such as a Markov chain Monte Carlo (MCMC) simulation, or variational estimation, such as a Variational Bayesian-Expectation Maximization (VB-EM) algorithm.

As shown in FIG. 5, abnormality detection model 126 is a model that integrates plural learning models. Specifically, the learning models include a production number model corresponding to the probability distribution of the production number (manufacturing number) during operation time, and a stop time model that corresponds to the probability distribution of the stop time during the operating time. In addition, the stop time model is created based on the probability distribution of the stop time for each stop factor. The method for creating abnormality detection model 126 is not limited to the above-mentioned examples.

### Use Phase

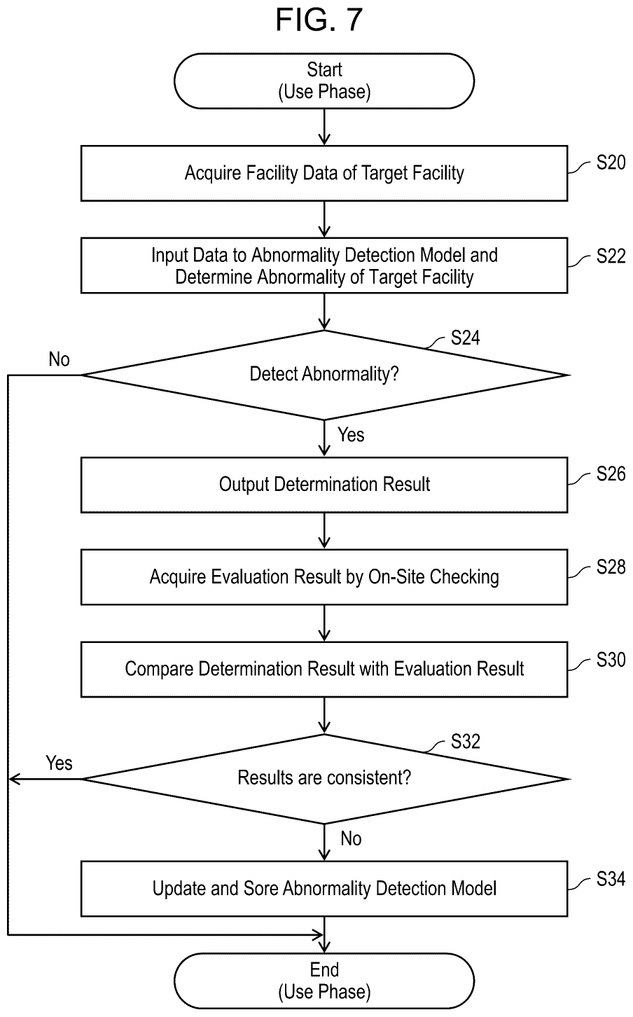

Next, processing in a use phase will be described with reference to FIG. 7. FIG. 7 is a flowchart illustrating the processing in the use phase of abnormality determination system 1 according to this embodiment.

As shown in FIG. 7, firstly, facility-information acquisition unit 110 acquires facility data of the target facility (S20). Based on the acquired facility data, facility-information acquisition unit 110 generates input data representing the operation performance of the target facility, and outputs the input data to determination unit 140. The input data corresponds to, for example, one line of data in log data 122. The input data may be stored in storage unit 120 as part of log data 122.

Next, determination unit 140 inputs the input data into abnormality detection model 126 and determines an abnormality of the target facility (S22). Specifically, determination unit 140 calculates the degree of abnormality of the target facility. As shown in FIG. 5, the degree of abnormality corresponds to the area of the region to the right of the actual measurement value (also referred to as the upper probability) in the probability distribution corresponding to abnormality detection model 126. The actual measurement value is a production takt calculated from the input data. If the upper probability is smaller than a threshold value, determination unit 140 determines that the target facility is abnormal (an abnormality is detected). If the upper probability is greater than the threshold value, determination unit 140 determines that the target facility is normal (no abnormality has been detected). The method of determining an abnormality is not limited to this.

As shown in FIG. 7, if no abnormality is detected in the target facility (“No” in S24), the abnormality determination processing ends. Alternatively, the processing may return to step S20, and the abnormality determination processing may be continued based on facility data of another target facility.

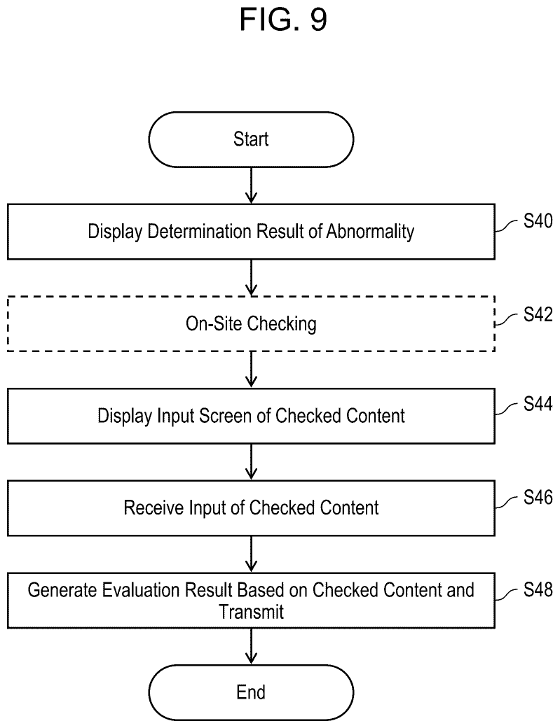

If an abnormality is detected in the target facility (“Yes” in S24), output unit 150 outputs a determination result (S26). Output unit 150 outputs the determination result to input/output device 200. Processing performed by input/output device 200 will be described later with reference to FIG. 9.

After abnormality determination device 100 outputs the determination result, abnormality determination device 100 stands by until the evaluation result by an on-site checking is obtained. During the standing-by period, steps S20 to S26 may be repeated using other facility data, and plural determination results may be output.

Next, evaluation-result acquisition unit 160 acquires the evaluation results of the target facility by an on-site checking (S28). Specifically, evaluation-result acquisition unit 160 acquires the evaluation results transmitted from input/output device 200.

Next, comparison unit 170 makes a comparison of the determination result with the evaluation result (S30). Comparison unit 170 makes the comparison and determines whether the determination result is consistent with the evaluation result or not. Specifically, comparison unit 170 determines whether an abnormality actually occurs (consistent) or whether an abnormality does not actually occur (not consistent) in the target facility in which an abnormality is detected by the determination result as a result of an on-site checking. The comparison result by comparison unit 170 is stored in storage unit 120 as comparison result 124.

If the determination result marches the evaluation result (“Yes” in S32), learning unit 130 ends the abnormality determination processing without updating abnormality detection model 126 stored in storage unit 120. Alternatively, the processing may return to step S20 and continue abnormality determination processing based on facility data of another target facility.

If the determination result is not consistent with the evaluation result (“No” in S32), learning unit 130 updates abnormality detection model 126 based on the evaluation result and stores the updated model in storage unit 120 (S34). Specifically, as shown in FIG. 5, learning unit 130 changes the threshold value for determining an abnormality based on the probability distribution corresponding to abnormality detection model 126. Alternatively, learning unit 130 may update the parameters of the probability distribution by performing re-learning.

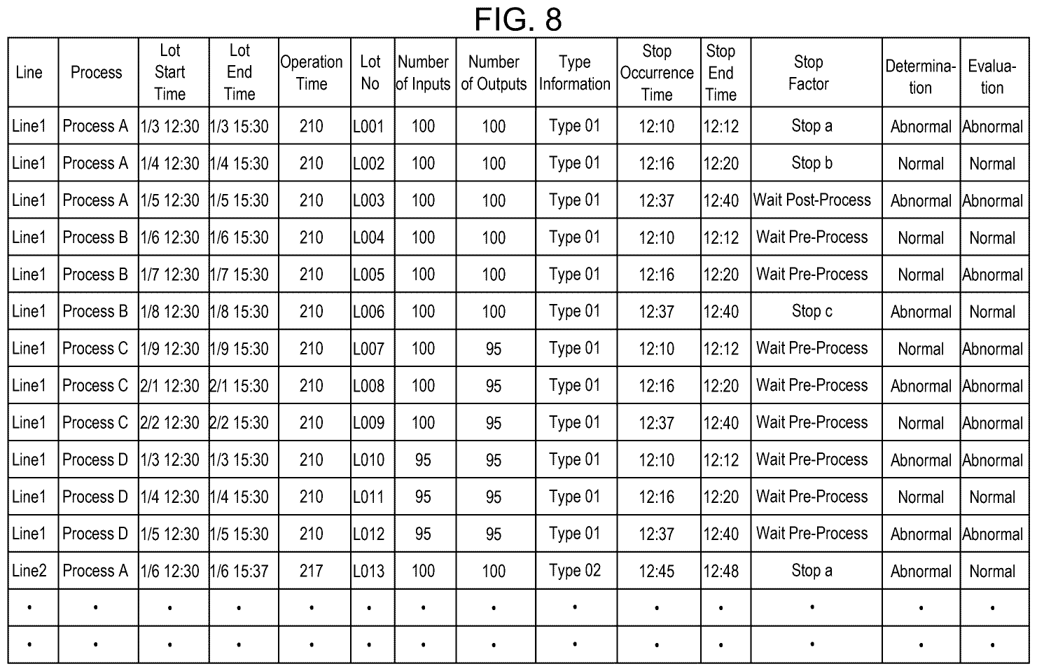

FIG. 8 illustrates an example of data for re-learning of machine learning. As shown in FIG. 8, the re-learning data includes the determination results and comparison results in addition to the learning data shown in FIG. 6. Information including the consistency or non-consistency of the determination results and the comparison results for re-learning enhances the accuracy of abnormality detection model 126. For example, if the determination result by abnormality detection model 126 in a certain case is incorrect, the correct determination result may be obtained if a similar case occurs next time.

FIG. 8 also shows the comparison results in the case that the determination result is normal. Abnormality determination device 100 may thus acquire evaluation results by worker 30 to perform the on-site checking even if the determination result is normal. For example, output unit 150 may output the determination result even if no abnormality is detected. Alternatively, worker 30 may periodically perform the on-site checking, regardless of the determination result.

Abnormality detection model 126 may be updated (S34) every time the comparison (S30) is made, or may be updated after plural comparison results has been obtained. Similarly, the comparison (S30) may be made each time an evaluation result is obtained, or may be updated after obtaining plural evaluation results has been obtained. If abnormality detection model 126 is updated each time the comparison is made, abnormality detection model 126 is kept up to date, enhancing the accuracy of abnormality determination. If abnormality detection model 126 is updated after obtaining a certain amount of comparison results, data available for updating are increased, and therefore, the accuracy of updated abnormality detection model 126 can be further enhanced. Accordingly, the accuracy of abnormality determination can be enhanced.

### Evaluation Processing by On-Site Checking

Evaluation processing by an on-site checking performed by worker 30 will be described below with reference to FIG. 9.

FIG. 9 is a flowchart illustrating processing related to the on-site checking by abnormality determination system 1 according to this exemplary embodiment. The processing shown in FIG. 9 is mainly executed by input/output device 200.

Firstly, in input/output device 200, if communication unit 210 acquires a determination result from abnormality determination device 100, display unit 230 displays determination result (S40).

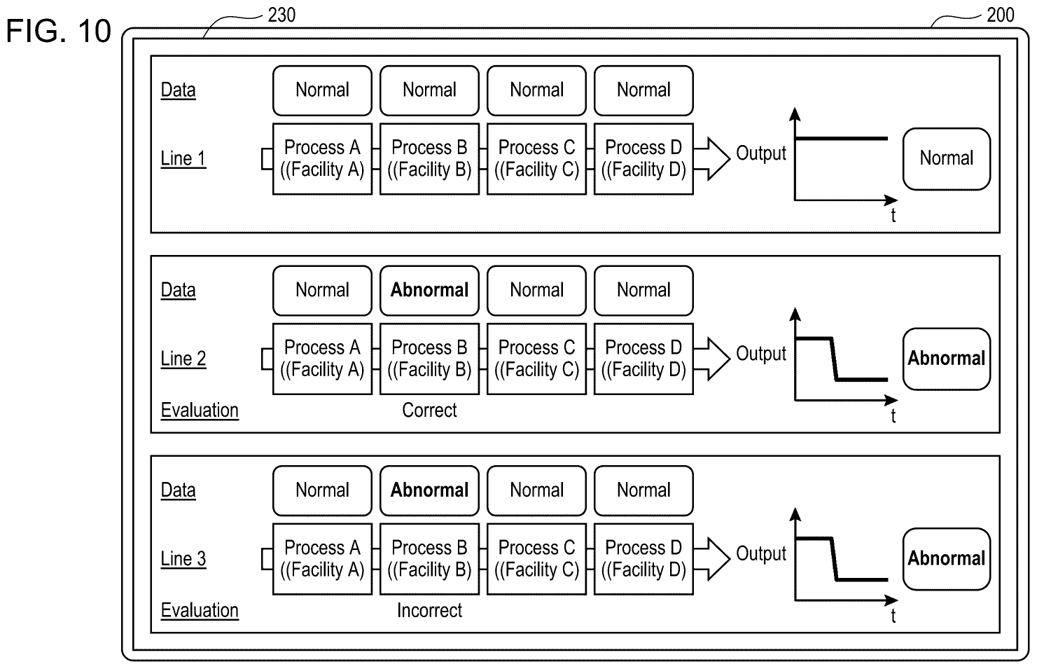

FIG. 10 illustrates an example of a notification screen that displays an abnormality determination result. For example, as shown in FIG. 10, a display screen includes determination results of normality and abnormality of each production line, and determination results of normality and abnormality of each process (facility) in each production line. In the example of FIG. 10, an abnormality is detected in process B (facility B) in both production line 2 and production line 3, respectively. Worker 30 can identify the facility (process) in which an abnormality occurs by viewing the display screen.

For this reason, as shown in FIG. 9, worker 30 performs an on-site checking (S42). Specifically, worker 30 actually goes to a place where the facility is installed and checks the state of the facility, and evaluates the abnormality situation of the facility.

Then, display unit 230 displays an input reception screen for inputting the result of the on-site checking (S44). The input reception screen includes, for example, a graphical user interface (GUI) object for allowing worker 30 to input whether or not an abnormality factor occurs for each abnormality factor item. Examples of the GUI object include, but are not limited to, text boxes or selection buttons.

Reception unit 240 receives an input from worker 30 via the input reception screen displayed on display unit 230 (S46). FIG. 11 illustrates an example of evaluation data indicating the evaluation results by the on-site checking. As shown in FIG. 11, the “date and time” and “lot number” are identification information for identifying the target facility. As shown in FIG. 6, the production line and process may also be included.

“Dust adhesion”, “foreign matter contamination”, and “wire disconnection” are items that represent the factors of generation of an abnormality. The type of the items is previously determined by abnormality determination system 1. Therefore, worker 30 only needs to input the results by the on-site checking for the items. “TRUE” for each item means that the corresponding item occurs, and “FALSE” means that the corresponding item does not occur. For example, it is shown that, for lot number “L001”, the results of the on-site checking indicate that “dust adhesion” and “wire disconnection” occur while “foreign matter contamination”, “tool abnormality”, and “arrangement abnormality” did not occur. If even one of the items is “TRUE,” that is, if an abnormality is found in at least one factor, the evaluation result of the target facility is “abnormal.” If all items are “FALSE,” that is, if no abnormality is found in any factors, the evaluation result of the target facility is “normal.” Items of the contents of the “Evaluation” in FIG. 11 may be input by worker 30, or may be the results generated by signal processing unit 250 based on the input results for each item indicating a factor of the abnormality.

As shown in FIG. 9, after reception of input, signal processing unit 250 generates an evaluation result based on the content of the input and transmits the generated evaluation result to abnormality determination device 100 via communication unit 210 (S48).

As described above, the on-site checking performed by worker 30 is performed according to predetermined items, and the input of the check results for each item is received. The items are determined so as to enhance accuracy of abnormality detection model 126. Therefore, the evaluation results from the on-site checking performed by worker 30 can be obtained as quantitative data.

Workers 30 in charge of facility 10 are often not an expert in machine learning. For this reason, feedback from worker 30 is likely to be inappropriate, and therefore, feedback may not enhance accuracy of abnormality detection model 126. In this case, worker 30 is likely to become dissatisfied with the abnormality determination system in which the accuracy is not enhanced although feedback is performed, and the motivation to provide feedback is decreased, which discouraging to enhance the accuracy of the abnormality detection model.

On the contrary, according to this exemplary embodiment, by categorizing the contents of input by worker 30, it is possible to quantify the evaluation contents according to a knowledge of worker 30. Information useful for enhancing accuracy of abnormality detection model 126 is obtained, enhancing the accuracy effectively.

### Other Exemplary Embodiment

As mentioned above, the abnormality determination device and the abnormality determination method according to one or more aspects have been described based on the exemplary embodiments, but the present disclosure is not limited to these exemplary embodiments. An embodiment obtained by making various modifications to the above exemplary embodiments that can be conceived by a person skilled in the art, and an embodiment in which constituent elements in different exemplary embodiments are combined, without materially departing from the spirit of the present disclosure are also included in this disclosure.

For example, the above exemplary embodiment shows an example of a configuration in which an abnormality determination device includes the comparison unit, but the configuration is not limited thereto. The comparison may be made by another device or may be performed by a worker. The abnormality determination device may acquire comparison result 124 by communicating with another device or by receiving an input of comparison result 124 from the worker.

For example, model creation part 134 may perform weighting of the data used in creating and updating of abnormality detection model 126. For example, model creation part 134 may change the weight of the comparison result based on the date and time of the comparison result. For example, if the comparison result is information obtained at the date and time prior to a predetermined threshold value, that is, old information, the weight of the comparison result may be reduced. In contrast, if the comparison result is information obtained at a date and time after the predetermined threshold date, that is, new information, the weight of the comparison result may be increased. That is to say, plural determination results and plural evaluation results are obtained at plural dates and times, and plural comparison results are obtained by comparing the determination results with the evaluation results. If the determination result is different from evaluation result in each comparison result, learning unit 130 updates abnormality detection model 126 based on the evaluation results. In this case, abnormality detection model 126 is updated with a higher weight for the evaluation results obtained after the predetermined threshold date among the evaluation results than for the evaluation results obtained before the threshold date.

Model creation part 134 may change the weight of the comparison result depending on the proficiency of worker 30 who performed the on-site checking that is the basis of the comparison result. The proficiency is a parameter determined based on, e.g., the number of working days, the work experience, or the evaluation from the manager of worker 30. In this case, storage unit 120 stores, for example, information indicating the proficiency of each worker. Evaluation-result acquisition unit 160 acquires information for identifying the proficiency, such as the identification number of workers 30 performing the on-site checking, together with the evaluation results. Model creation part 134 may increase the weight of the comparison result based on the on-site checking performed by worker 30 having proficiency higher than the threshold value, and may decrease the weight of the comparison result based on the on-site checking performed by worker 30 having proficiency lower than the threshold value. That is to say, learning unit 130 obtains plural evaluation results by plural workers, and updates abnormality detection model 126 based on the evaluation results if the determination result in the comparison result is different from the evaluation result. In this case, among the evaluation results, the weight of the evaluation result based on the on-site checking performed by worker 30 having proficiency higher than the threshold value is increased, and the weight of the evaluation result based on the on-site checking performed by worker 30 having proficiency lower than the threshold value is decreased compared to the above evaluation results, thereby updating abnormality detection model 126.

The communication method between the devices described in the above exemplary embodiment is not particularly limited. If wireless communication is performed between the devices, the wireless communication method (communication standard) is, for example, short-range wireless communication, such as ZigBee (registered trademark), Bluetooth (registered trademark), or wireless LAN (Local Area Network). Alternatively, the wireless communication method (communication standard) may be communication via a wide range communication network such as the Internet. Wired communication may be performed between the devices instead of wireless communication. Specifically, the wired communication is communication using power line communication (PLC) or a wired LAN.

In accordance with the above embodiment, the processing executed by a specific processing unit may be executed by another processing unit. Furthermore, the order of the plurality of processing may be changed, or plurality of processing may be executed in parallel. Furthermore, the allocation of constituent elements provided in a work notification system to a plurality of devices is one example. For example, constituent elements provided in one device may be provided by another device.

For example, the processing described in accordance with the above embodiment may be implemented by centralized processing using a single device (system), or may be implemented by distributed processing using a plurality of devices. Furthermore, the processor that executes the above program may be single or multiple. In other words, centralized processing or distributed processing may be performed.

Specifically, abnormality determination device 100 may perform at least a part of the functions of input/output device 200. For example, input/output device 200 may be a device dedicated to inputting, and abnormality determination device 100 may include the output function of input/output device 200. In this case, output unit 150 of abnormality determination device 100 performs the functions of display control unit 220 and display unit 230.

Alternatively, input/output device 200 may be a device dedicated to outputting, and abnormality determination device 100 may have the input function of input/output device 200. In this case, evaluation-result acquisition unit 160 of abnormality determination device 100 performs the functions of reception unit 240 and signal processing unit 250. In this case, abnormality determination device 100 may have display control unit 220 and display unit 230, and may support the worker in inputting the evaluation results via display unit 230.

Alternatively, abnormality determination device 100 may perform all of the functions of input/output device 200. In other words, abnormality determination device 100 and input/output device 200 may be integrated into a single device.

In accordance with the above embodiment, all or part of the constituent elements, such as the control unit, may be configured with dedicated hardware, or may be implemented by executing a software program suitable for each constituent element. Each constituent element may be implemented by a program execution unit such as a central processing unit (CPU) or a processor reading and executing a software program recorded on a recording medium such as an HDD or semiconductor memory.

Constituent elements, such as the control unit, may be composed of one or plural electronic circuits. Each of the one or plural electronic circuits may be a general-purpose circuit or a dedicated circuit.

The one or more electronic circuits may include, for example, a semiconductor device, an IC, an LSI, or the like. The IC or LSI may be integrated on one chip or on a plurality of chips. Herein, name of IC or LSI is used, but the name may be changed depending on the degree of integration, and the name may be a system LSI, very large scale integration (VLSI), or ultra large scale integration (ULSI). Also, an FPGA that is programmed after the LSI is manufactured can be used for the same purpose.

In addition, the general or specific aspects of the present disclosure may be implemented as a system, an apparatus, a method, an integrated circuit, or a computer program. Alternatively, the present disclosure may be implemented as a computer-readable non-temporary recording medium, such as an optical disk, an HDD, or a semiconductor memory, on which the computer program is stored. The present disclosure may also be implemented as any combination of a system, an apparatus, a method, an integrated circuit, a computer program, and a recording medium.

Each of the above exemplary embodiments may be modified, substituted, added, or omitted within the scope of the claims or the equivalents thereof.

### INDUSTRIAL APPLICABILITY

The present disclosure may be used as an abnormality determination device and an abnormality determination method that can determine abnormalities with high accuracy, and can be used in, for example, factory management systems and production systems.

### REFERENCE MARKS IN THE DRAWINGS

1 abnormality determination system
10 facility
20 network
30 worker
100 abnormality determination device
110 facility-information acquisition unit
120 storage unit
122 log data
124 comparison result
126 abnormality detection model
130 learning unit
132 request part
134 model creation part
140 determination unit
150 output unit
160 evaluation-result acquisition unit
170 comparison unit
200 input/output device
210 communication unit
220 display control unit
230 display unit
240 reception unit
250 signal processing unit

1. An abnormality determination device comprising:
a learning unit configured to provide an abnormality detection model for detecting an abnormality of a facility by machine learning using log data that represent operation performance of the facility;
a determination unit configured to input data representing operation performance of a target facility and determine an abnormality of the target facility; and
an output unit configured to output a determination result by the determination unit, wherein
if the determination result is different from an evaluation result of an on-site checking of the target facility, the learning unit is configured to update the abnormality detection model based on the evaluation result.

2. The abnormality determination device according to claim 1, further comprising
a comparison unit configured to make a comparison of the determination result with the evaluation result, wherein
if the determination result is different from the evaluation result, the learning unit is configured to update the abnormality detection model based on the evaluation result.

3. The abnormality determination device according to claim 2, wherein if the determination result indicates that the target facility is abnormal, the comparison unit is configured to make the comparison, and if the determination result indicates that the target facility is normal, the comparison unit is configured not to make the comparison.

4. The abnormality determination device according to any one of claim 1, wherein
if the determination result indicates that the target facility is abnormal, the output unit is configured to output the determination result, and
if the determination result indicates that the target facility is normal, the output unit is configured not to output the determination result.

5. The abnormality determination device according to any one of claim 1, further comprising an acquisition unit configured to acquire the evaluation result.

6. The abnormality determination device according to any one of claim 1, further comprising a storage unit configured to store the log data and the abnormality detection model.

7. A method of determining an abnormality, comprising:
creating an abnormality detection model, for detecting an abnormality of a facility, by machine learning using log data representing operation performance of the facility;
determining an abnormality of a target facility by inputting data representing operation performance of the target facility to the abnormality detection model; and
outputting a result obtained by said determining of the abnormality, wherein
if the result is different from an evaluation result of the target facility by an on-site checking, said creating the abnormality detection model comprises updating the abnormality detection model based on the evaluation result.

8. A program for causing a computer to execute the method according to claim 7.

9. A recording medium recording a program for causing a computer to execute the method according to claim 7.
